(19) United States
(12) Patent Application Publication
(10) Pub. No.: US 2025/0094689 A1
(43) Pub. Date: Mar. 20, 2025

(54) PROCESSING METHOD AND APPARATUS, AND ELECTRONIC DEVIC

(71) Applicant: Lenovo (Beijing) Limited, Beijing (CN)

(72) Inventors: Wei ZHENG, Beijing (CN); Dan SONG, Beijing (CN)

(21) Appl. No.: 18/882,732

(22) Filed: Sep. 11, 2024

(30) Foreign Application Priority Data
Sep. 20, 2023 (CN) 202311220036.6

(51) Int. Cl. G06F 40/166; G06F 3/04845

(52) U.S. Cl. CPC G06F 40/166; G06F 3/04845; G06F 2203/04806

(57) ABSTRACT

A processing method includes obtaining an interactive operation for a text content, in response to the text content being in a first operation mode, adjusting a summary content corresponding to the text content according to an operation parameter of the interactive operation, and in response to the text content being in a second operation mode, adjusting a display scale of a display screen corresponding to the text content according to the operation parameter of the interactive operation. Under different operation parameters, a quantity of summary sentences included in the summary content is different. The summary content includes at least one summary sentence.

### CROSS-REFERENCE TO RELATED APPLICATION

The present disclosure claims priority to Chinese Patent Application No. 202311220036.6, filed on Sep. 20, 2023, the entire content of which is incorporated herein by reference.

### TECHNICAL FIELD

The present disclosure relates to the data processing technology field and, more particularly, to a processing method, a processing apparatus, and an electronic device.

### BACKGROUND

When a user browses a document on a terminal device, the user is only able to read the entire content of the document and summarize a summary based on self-understanding. To obtain the summary content satisfying the needs, the user needs to adjust the summary content themselves.

However, in the above method of obtaining the summary, the user needs to perform a plurality of steps, which causes the user operation to be highly complex. Thus, the efficiency of obtaining the summary content is low.

### SUMMARY

The present disclosure provides a processing method. The method includes obtaining an interactive operation for a text content, in response to the text content being in a first operation mode, adjusting a summary content corresponding to the text content according to an operation parameter of the interactive operation, and in response to the text content being in a second operation mode, adjusting a display scale of a display screen corresponding to the text content according to the operation parameter of the interactive operation. Under different operation parameters, a quantity of summary sentences included in the summary content is different. The summary content includes at least one summary sentence.

The present disclosure provides a processing apparatus, including an operation acquisition unit, a first processing unit, and a second processing unit. The operation acquisition unit is configured to obtain an interactive operation for a text content, trigger a first processing unit in response to the text content being in a first operation mode, and trigger a second processing unit in response to the text content being in a second operation mode. The first processing unit is configured to adjust a summary content corresponding to the text content according to an operation parameter of the interactive operation. The summary content includes at least one summary sentence. The second processing unit is configured to adjust a display scale of a display screen corresponding to the text content according to the operation parameter of the interactive operation. Under different operation parameters, a quantity of summary sentences included in the summary content is different.

The present disclosure provides an electronic device, including an input/output apparatus and one or more processors configured to output a text content and obtain an interactive operation for the text content. The one or more processors are configured to, in response to the text content being in a first operation mode, adjust a summary content corresponding to the text content according to an operation parameter of the interactive operation in response to the text content being in a second operation mode, adjust a display scale of a display screen corresponding to the text content according to the operation parameter of the interactive operation. The summary content includes at least one summary sentence. Under different operation parameters, a quantity of summary sentences included in the summary content is different.

### BRIEF DESCRIPTION OF THE DRAWINGS

FIG. 1 illustrates a schematic flowchart of a processing method according to some embodiments of the present disclosure.

FIG. 2 illustrates a schematic flowchart of another processing method according to some embodiments of the present disclosure.

FIG. 3 illustrates a schematic diagram of an interaction operation according to some embodiments of the present disclosure.

FIG. 4, FIG. 5, and FIG. 6 illustrate schematic diagrams of displaying a target content and a text content according to some embodiments of the present disclosure.

FIG. 7 and FIG. 8 illustrate schematic diagrams of a focus point area according to some embodiments of the present disclosure.

FIG. 9 illustrates a schematic structural diagram of a processing apparatus according to some embodiments of the present disclosure.

FIG. 10 illustrates a schematic structural diagram of an electronic device according to some embodiments of the present disclosure.

FIG. 11 illustrates a schematic diagram of adjusting an abstract through a zoom-in operation and a zoom-out operation in a text file viewing scenario applied to a cell phone according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure.

Obviously, described embodiments are merely some embodiments of the present disclosure not all embodiments. Based on embodiments of the present disclosure, all other embodiments obtained by those skilled in the art without creative efforts are within the scope of the present disclosure.

FIG. 1 illustrates a schematic flowchart of a processing method according to some embodiments of the present disclosure. The method can be applied to an electronic device capable of outputting a text content and performing data processing, such as a cell phone, a tablet, or a laptop. The technical solutions of the present disclosure are used to improve the efficiency of obtaining the summary.

In some embodiments, the method of embodiments of the present disclosure includes the following processes.

At 101, an interactive operation for the text content is obtained.

The text content can be output on an input-output apparatus of the electronic device, such as a touchscreen. The interactive operation can refer to an operation capable of adjusting the display scale of the display screen corresponding to the text content, such as a zoom-in operation or a zoom-out operation.

In some embodiments, the interactive operation can be obtained through the input-output apparatus of the electronic device.

At 102, an operation mode of the text content is detected. If the text content is in a first operation mode, proceed to process 103, and if the text content is in a second operation mode, proceed to process 104.

The first operation mode can be an operation mode for adjusting the summary corresponding to the text content, while the second operation mode can be an operation mode for adjusting the display screen of the text content.

In some embodiments, the text content can correspond to a mode identifier, such as 0, 1, or 2. In some embodiments, the operation mode of the text content can be detected according to the mode identifier of the text content. For example, if the mode identifier is 0, the text content can be determined to be in the first operation mode. If the mode identifier is 1, the text content can be determined to be in the second operation mode.

At 103, the summary content corresponding to the text content is adjusted according to an operational parameter of the interactive operation. The summary content includes at least one summary sentence. Under different operation parameters, different quantities of summary sentences are included in the summary content.

When the text content is in the first operation mode, the operation parameter can represent a change amount of increasing or decreasing the quantity of summary sentences in the summary content. Based on this, in process 103, the summary content can be adjusted according to the change amount represented by the operational parameter, so that the quantity of summary sentences in the summary content can be increased or decreased.

Under different operation parameters, the content of the summary sentence included in the summary content can also be adjusted to cause the summary sentences included in the summary content to be different. Thus, the summary content formed by different quantities of summary sentences can describe the gist of the text content. For example, the gist of the text content can be described by the summary content with 5 summary sentences or 1 summary sentence. Thus, the summary content can be more precise and simpler. In another example, under the operation parameter of the interactive operation, the summary sentence can be adjusted from 1 to 6. Thus, more summary sentences can be used to represent the gist of the text content to cause the content described in the summary content to be richer.

In some embodiments, when the summary content is generated, the text content can be processed using a generative pre-trained transformer model, such as a GPT model, to obtain the summary content corresponding to the text content.

At 104, the display scale of the display screen corresponding to the text content is adjusted according to the operation parameter of the interactive operation.

When the text content is in the second operation mode, the operation parameter can represent the change amount of increasing or decreasing the display scale of the display screen. Based on this, in process 104, the display screen can be adjusted according to the change amount represented by the operation parameter to increase or decrease the display scale of the display screen.

For example, under the operation parameter of the interactive operation, the display scale of the display screen corresponding to the text content can be adjusted from 100% to 50%. For another example, under the operation parameter of the interactive operation, the display scale of the display screen corresponding to the text content can be adjusted from 30% to 70%.

Based on the above technical solution, in the processing method of embodiments of the present disclosure, after obtaining the interactive operation for the text content, the corresponding summary content or the display scale of the display screen corresponding to the text content can be adjusted according to different operation modes of the text content. Under different operation parameters, the quantity of summary sentences in the adjusted summary content can be different. Thus, in some embodiments, by recognizing the operation mode of the text content and the operation parameter of the interactive operation, the corresponding summary content or display scale can be adjusted. Thus, based on the implementation of the operation goal, the quantity of operations can be reduced, and the operation complexity can be lowered to improve the efficiency of obtaining the summary content.

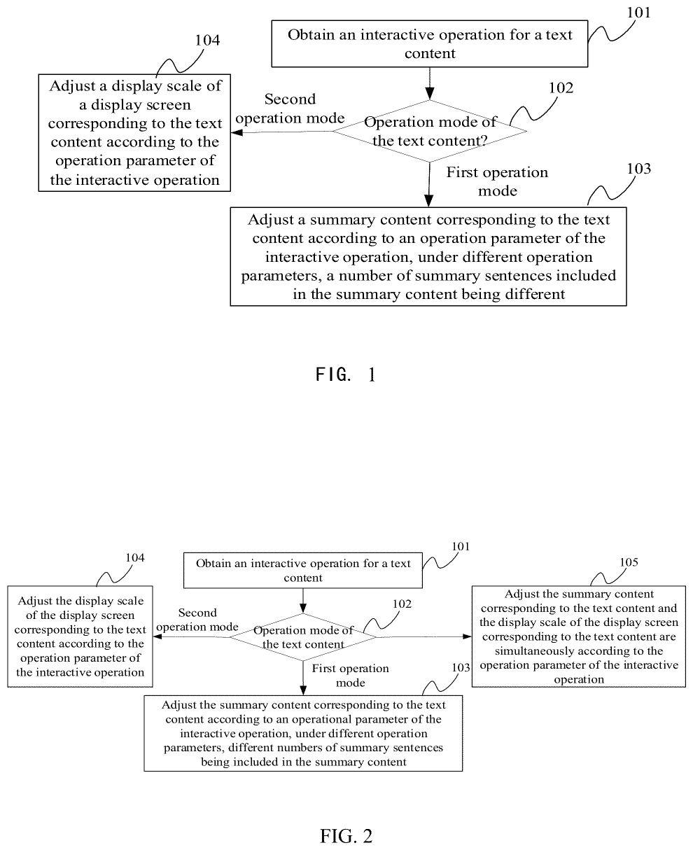

In some embodiments, when the text content is detected to be in the third operation mode in process 102, e.g., when the mode identifier is 2, the text content can be determined to be in the third operation mode. Then, the method further includes the following processes shown in FIG. 2.

At 105, the summary content corresponding to the text content and the display scale of the display screen corresponding to the text content are simultaneously adjusted according to the operation parameter of the interactive operation.

When the text content is in the third operation mode, the operation parameter can represent the change amount of increasing or decreasing the quantity of the summary sentences in the summary content and can also represent the change amount of increasing or decreasing the display scale of the display screen.

Based on this, in process 105, the summary content can be adjusted according to the change amount represented by the operation parameter to increase or decrease the quantity of the summary sentences included in the summary content. Meanwhile, in process 105, the display screen can be adjusted according to the change amount represented by the operation parameter to increase or decrease the display scale of the display screen.

For example, under the operation parameter of the interactive operation, the display scale of the display screen corresponding to the text content can be adjusted from 100% to 50%. Meanwhile, the quantity of summary sentences can be adjusted from 1 to 6. Thus, more summary sentences can be used to describe the gist of the text content to cause the content expressed by the summary content to be richer.

For another example, under the operation parameter of the interactive operation, the display scale of the display screen corresponding to the text content can be adjusted from 30% to 70%. Meanwhile, the summary sentences can be adjusted from 10 to 3. Thus, fewer summary sentences can be used to describe the gist of the text content to cause the summary content to be more concise.

In some embodiments, the operation parameter can correspondingly indicate adjusting the display scale to increase or decrease the corresponding ratio.

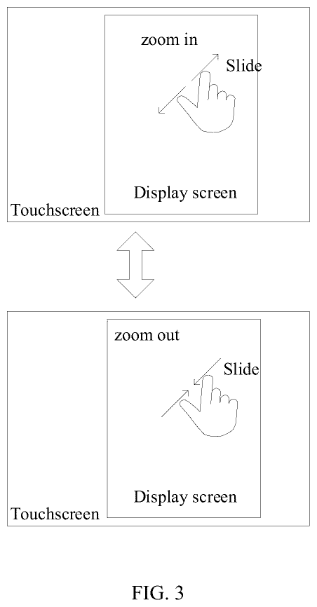

In some embodiments, the operation parameter can be generated based on an operation trajectory of the interactive operation. For example, as shown in FIG. 3, the interactive operation is an operation in which a plurality of fingers of the user slide relatively on the touchscreen. The operation parameter is generated based on the length of the operation trajectory of the fingers sliding on the touchscreen. The longer the operation trajectory is, the greater the change amount of the ratio value indicated by the operation parameter relative to the display scale before the change is. The shorter the operation trajectory is, the smaller the change amount of the ratio value indicated by the operation parameter relative to the display scale before the change is.

Based on this, when the display scale is within a first value range, i.e., when the ratio value indicated by the operation parameter is within the first value range, the quantity of summary sentences included in the summary content can be a first quantity.

When the display scale is within a second value range, i.e., when the ratio value indicated by the operation parameters is within the second value range, the quantity of summary sentences in the summary content can be a second quantity.

The first value range can be greater than the second value range. The first quantity can be less than the second quantity.

The first value range being greater than the second value range can indicate that a minimum value of the first value range is greater than a maximum value of the second value range. That is, the ratio value indicated by the operation parameter can be larger. Correspondingly, the quantity of the summary sentences included in the summary content can be smaller.

For example, as shown in FIG. 3, the user performs an interactive operation including a zoom-in or zoom-out interactive operation with the plurality of fingers on the touchscreen. As the user continuously performs the zoom-in operation on the display screen of the text content (i.e., increases the display scale), the gist of the text content can be described with fewer summary sentences in the summary content corresponding to the text content until the display screen is zoomed in to the largest. The summary content can express the gist of the text content with a smallest set of summary sentences such as a sentence. As the user continuously performs the zoom-out operation the display screen of the text content (i.e., decreases the display scale), the gist of the text content can be described with more summary sentences in the summary content corresponding to the text content, until the display screen is zoomed out to the smallest. The gist of the text content can be described with a largest set of summary sentences, e.g., 10 sentences.

In some embodiments, a corresponding summary level can be determined first based on the value range of the ratio value indicated by the operation parameter. Different summary levels can correspond to different quantities of sentences and different concise levels of the content corresponding to the summary content. For example, when the levels of the summary are higher, the quantity of the sentences in the summary content can be smaller. When the level of the summary is lower, the quantity of sentences corresponding to the summary content can be larger, and the content of the summary content can be less concise. Based on this, the summary content can be generated according to the summary level.

For example, as shown in FIG. 3, the user performs an interactive operation such as a zoom-in operation or zoom-out operation on the touchscreen using a plurality of fingers. As the user continues to perform the zoom-in operation on the display screen of the text content (i.e., increasing the display scale), the corresponding summary level decreases. Based on this, the content gist corresponding to the text content can be expressed with fewer summary sentences in the summary content corresponding to the text content, until the display screen is zoomed in to the largest. When the summary level is lowest, the summary content can be used to express the gist of the text content with the smallest set of the summary sentence, e.g., one sentence. As the user continuously performs the zoom-out operation on the display screen of the text content (i.e., decreasing the display scale), the level of the corresponding summary can be higher and higher. Based on this, the gist of the text content can be expressed with more summary sentences in the summary content corresponding to the text content, until the display screen is zoomed out to the smallest. The level of the summary is higher, the gist of the text content can be expressed by the largest set of the summary sentences of the summary content, e.g., 10 sentences.

Based on the above solution, in process 103, adjusting the summary content corresponding to the text content according to the operation parameter of the interactive operation can include, when the display screen is at a minimum scale value, and if the operation parameter indicates adjusting the display scale to become smaller, obtaining a target content related to the text content first, and obtaining then the summary content according to the target content and the text content.

In some embodiments, when the summary content is generated, the generative pre-trained Transformer model such as a GPT model can be used to process the text content and the target content to obtain the summary content corresponding to the text content.

The target content can be content found in at least one data source according to a target keyword. The target keyword can be a keyword within the text content, and the target content can include at least one keyword that matches the target keyword.

The data source of embodiments of the present disclosure can include at least one of local databases on the electronic device having the text content, a specialized database related to the text content, or an open-source online database.

Based on this, in some embodiments, when the display screen of the text content is at the minimum scale value and the obtained operation parameter of the interactive operation indicates a further decrease in the display scale, the quantity of summary sentences in the summary content can be further increased, or the quantity of summary sentences can remain unchanged, however, the summary content can be generated in connection with the text content and the target content associated with the text content to compensate the content gist expressed by the summary content.

For example, as shown in FIG. 3, the user performs a zoom-out interactive operation on the touchscreen through the plurality of fingers. As the user continues to perform the zoom-out operation the display screen of the text content, the display screen can be caused to be at the minimum scale value, e.g., 10%. Then, if the user continues to perform the zoom-out operation on the touchscreen, the summary content can be generated in connection with the text content and the related document found in the Internet or the related document found in the specialized database. The quantity of the summary sentences in the summary content can be increased or unchanged.

Furthermore, in process 103, after the summary content is obtained based on the target content and the text content, the target content can also be displayed. Of course, the text content can be also displayed.

The target content and the text content can be displayed in any of the following methods.

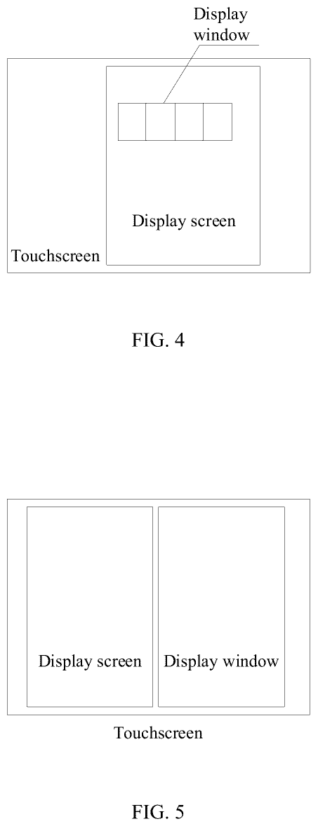

In a display method, as shown in FIG. 4, a display window having the target content is displayed as a floating window above the display screen corresponding to the text content. Then, the display window having the target content is displayed in a thumbnail format to indicate that the summary content is generated based on the target content and the text content.

In another display method, as shown in FIG. 5, the display window having the target content is displayed side by side with the display screen corresponding to the text content. Then, the display scale of the target content in the display window having the target content can be consistent with the display scale of the display screen corresponding to the text content to indicate the content used to generate the summary content.

In yet another display method, the display window having the target content can be displayed and overlaid with the display screen corresponding to the text content, and the display screen can be output at the top. As shown in FIG. 6, the display scale of the target content in the display window can be consistent with the display scale of the display screen corresponding to the text content. However, a part of the content can be blocked by the display screen corresponding to the text content at the top or by other display windows having the target content to indicate that the summary content is generated based on the target content and the text content.

In some embodiments, the summary content can be at least related to the content in the focus point area and the operation parameter. The operation parameter can include at least an operation focus point of the interactive operation.

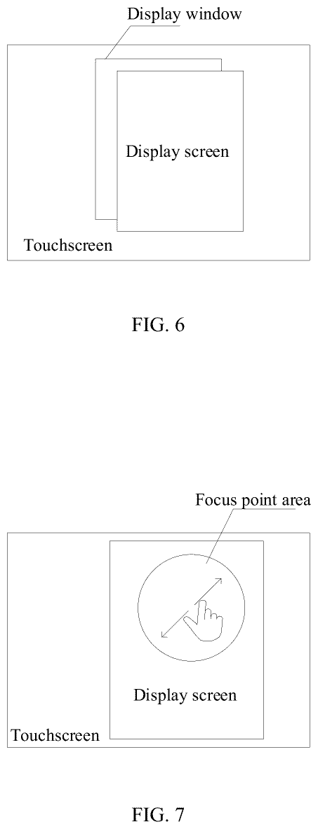

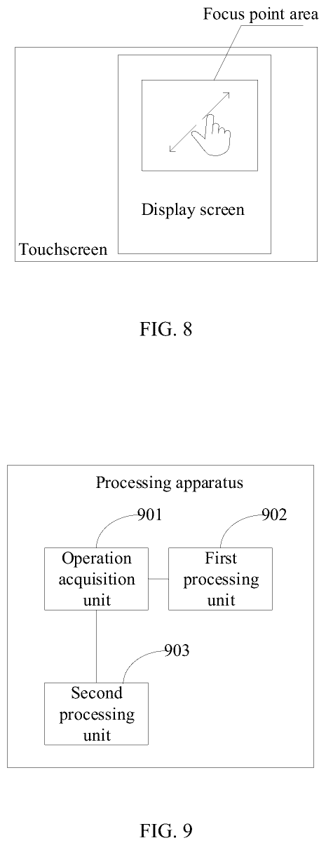

The focus point area can refer to the content area where the operation focus point is in the display screen of the text content. For example, as shown in FIG. 7, the focus area is a circular area centered on a center point of the operation trajectory of the plurality of fingers of the user and with a first value as the radius. In some other embodiments, as shown in FIG. 8, the focus point area is a rectangular area centered on the center point of the operation trajectory of the plurality of fingers of the user with a second value as the width and a third value as the height.

In some embodiments, when the summary content is generated, the quantity of summary sentences in the summary content can be determined according to the operation parameter, such as 3 or 10. Then, according to the quantity of the summary sentences and based on the content in the focus point area, the summary sentences with the corresponding quantity can be generated. The summary sentences can form the summary content.

As the user performs the interactive operation on the text content, the focus point area can remain unchanged or change accordingly based on the operation mode of the text content.

For example, when the text content is in the first operation mode, and if the operation parameter indicates increasing the display scale, the display scale of the display screen corresponding to the text content may not change, but the size of the focus point area can decrease synchronously according to the operation parameter. The change amount of the decrease in the focus point area can be consistent with the change amount of the increase in the display scale indicated by the operation parameter. Correspondingly, when the content of the focus point area used to generate the summary content decreases, the quantity of summary sentences can decrease as well. If the operation parameter indicates adjusting the display scale to be smaller, the display scale of the display screen corresponding to the text content can be unchanged. However, the size of the focus point area can increase synchronously according to the operation parameter. The change amount of the increase in the focus point area can be consistent with the change amount of the decrease in the display scale indicated by the operation parameter. Correspondingly, when the content of the focus point area used to generate the summary content can increase, the quantity of summary sentences can increase, until the display screen corresponding to the text content is adjusted to the minimum display scale. The focus point area can be the area where the entire text content is located. Then, if the operation parameter of the interactive operation that is obtained again indicates of the continuous decrease in the display scale, the summary content can be generated in connection with the text content and the target content.

In some embodiments, when the text content is in a second operation mode, and if the operation parameter indicates the increase in the display scale, the display scale of the display screen corresponding to the text content can increase, but the size of the focus point area can be unchanged. Correspondingly, the content in the focus point area can decrease. If the operation parameter indicates a decrease in the display scale, the display scale of the display screen corresponding to the text content can decrease, but the size of the focus point area can be unchanged. Correspondingly, the content in the focus point area can increase.

In some embodiments, when the text content is in the third operation mode, and if the operation parameter indicates the increase in the display scale, the display scale of the display screen corresponding to the text content can increase, but the size of the focus point area can be unchanged. Correspondingly, the content of the focus point area used to generate the summary content can decrease, and the quantity of summary sentences can decrease. If the operation parameter indicates adjusting the display scale to be smaller. The display scale of the display screen corresponding to the text content can decrease, but the size of the focus point area can be unchanged. Correspondingly, the content of the focus point area used to generate the summary content can increase, and the quantity of summary sentences can increase too, until the display screen corresponding to the text content is adjusted to be at the minimum display scale. The focus point area can be the area where the entire text content is. Then, if the operation parameter of the interactive operation that is obtained again indicates of continuously decreasing the display scale, the summary content can be generated in connection with the text content and the target content.

Thus, in some embodiments, under different operation parameters, the summary content can be generated based on the content in different focus point areas, and the quantity of summary sentences in the summary content can be different. However, the summary content can express the gist of the text content.

For example, as shown in FIG. 3, the user performs the zoom-in interactive operation or the zoom-out interactive operation on the touchscreen through the plurality of fingers. As the user continues to perform the zoom-in operation the display screen of the text content (i.e., increasing the display scale) of the text content, the content included in the rectangular area as the focus point area can decrease continuously. Then, the gist of the content of the rectangular area can be expressed with fewer summary sentences in the summary content, until the display screen is zoomed in to the maximum. The gist of the text content can be expressed by the summary content with the smallest set of summary sentences, e.g., one sentence. However, as the user continuously performs the zoom-out operation the display screen of the text content (i.e., decreasing the display scale), the content included in the rectangular area as the focus point area can continuously increase, until the display screen is zoomed out to the minimum. The gist of the text content can be expressed by the summary content with the largest set of summary sentences, e.g., 10 sentences. If the user continues to perform the zoom-out operation on the touchscreen, the summary content can be generated in connection with the text content and the related document found in the internet or the related document found in the specialized database.

FIG. 9 illustrates a schematic structural diagram of a processing apparatus according to some embodiments of the present disclosure. The apparatus can be configured in the electronic device capable of outputting the text content and performing the data processing, such as a mobile phone, a tablet, or a laptop. The technical solution of embodiments of the present disclosure can be primarily used to improve the efficiency of obtaining the summary content.

In some embodiments, the apparatus of embodiments of the present disclosure includes an operation acquisition unit 901, a first processing unit 902, and a second processing unit 903.

The operation acquisition unit 901 can be configured to obtain the interactive operation for the text content, in response to the text content being in the first operation mode, trigger the first processing unit 902, and in response to the text content being in the second operation mode, trigger the second processing unit 903.

The first processing unit 902 can be configured to adjust the summary content corresponding to the text content according to the operation parameter of the interactive operation. The summary content includes at least one summary sentence.

The second processing unit 903 can be configured to adjust the display scale of the display screen corresponding to the text content according to the operation parameter of the interactive operation.

Under different operation parameters, the quantity of summary sentences included in the summary content can be different.

According to the above technical solutions, embodiments of the present disclosure provide the processing apparatus. After obtaining the interactive operation for the text content, the corresponding summary content can be adjusted according to different operation modes of the text content, or the display scale of the display screen corresponding to the text content can be adjusted. Under different operation parameters, the quantity of summary sentences in the adjusted summary content can be different. Thus, in embodiments of the present disclosure, by recognizing the operation mode of the text content and the operation parameter of the interactive operation, the summary content or the display scale can be correspondingly adjusted. Then, the quantity of operations can be reduced while realizing the operation goals, the operation complexity can be lowered, and the efficiency of obtaining the summary content can be improved.

In some embodiments, the operation acquisition unit 901 can be configured to trigger the first processing unit 902 and the second processing unit 903 when the text content is in the third operation mode. Thus, according to the operation parameter of the interactive operation, the summary content corresponding to the text content and the display scale of the display screen corresponding to the text content can be adjusted simultaneously.

In some embodiments, the operation parameter can correspondingly indicate adjusting the display scale to increase or decrease to a corresponding scale value. When the display scale is in the first value range, the summary content can include a first quantity of summary sentences. When the display scale is in the second value range, the summary content can include a second quantity of summary sentences. The first value range can be greater than the second value range, and the first quantity can be smaller than the second quantity.

In some embodiments, when the first processing unit 902 adjusts the summary content corresponding to the text content according to the operation parameter of the interactive operation, the first processing unit 902 can be configured to, when the display screen is at the minimum scale value, and if the operation parameter indicates of adjusting the display scale to decrease, obtain the target content associated with the text content, and obtain the summary content according to the target content and the text content.

In some embodiments, the target content can be the content obtained by searching in at least one data source according to the target keyword. The target keyword can be the keyword within the text content. The target content can include at least one keyword that matches the target keyword.

In some embodiments, after obtaining the summary content according to the target content and the text content, the first processing unit 902 can be further configured to display the target content. The target content and the text content can be displayed in any of the following methods.

The display window having the target content can be displayed as a floating window above the display screen.

The display window can be displayed side by side with the display screen.

The display window can be displayed and overlaid with the display screen, and the display screen can be output at the top.

In some embodiments, the summary content can be at least related to the content in the focus point area and the operation parameter. The operation parameter can at least include the operation focus point of the interactive operation. The focus point area can be a content area where the operation focus point is in the display screen of the text content.

In some embodiments, the generative pre-trained transformer (GPT) model can be configured to process at least the text content to obtain the summary content corresponding to the text content.

For specific implementations of the units of embodiments of the present disclosure, reference can be made to corresponding contents above, which are not repeated here.

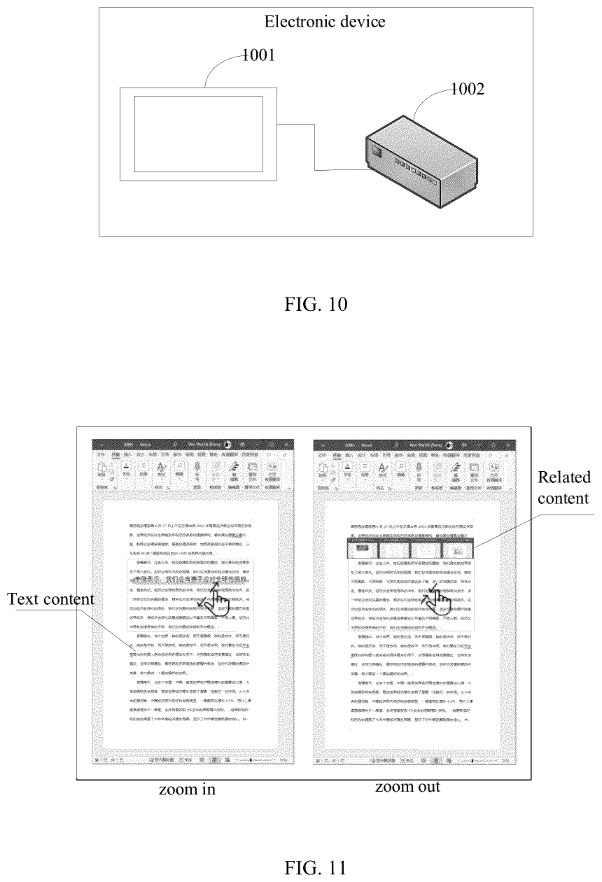

FIG. 10 illustrates a schematic structural diagram of an electronic device according to some embodiments of the present disclosure. The electronic device includes an input/output apparatus 1001 and a processor 1002.

The input/output apparatus 1001, such as a touchscreen, can be configured to output the text content and obtain the interactive operation for the text content.

The processor 1002 can be configured to adjust the summary content corresponding to the text content according to the operation parameter of the interactive operation in response to the text content being in the first operation mode, the summary content can include at least one summary sentence, and adjust the display scale of the display screen corresponding to the text content according to the operation parameter of the interactive operation in response to the text content being in the second operation mode.

Under different operation parameters, the quantity of summary sentences included in the summary content can be different.

Based on the above technical solutions, embodiments of the present disclosure provide the electronic device. After obtaining the interactive operation for the text content, the corresponding summary content can be adjusted when the text content is in different operation modes, or the display scale of the display screen corresponding to the text content can be adjusted. Under different operation parameters, the quantity of the summary sentences in the adjusted summary content can be different. Thus, by recognizing the operation mode of the text content and the operation parameter of the interactive operation, the corresponding summary content or the display scale can be adjusted. Thus, the quantity of operations can be reduced while the operation goals are realized, the operation complexity can be lowered, and the efficiency of obtaining the summary content can be improved.

For example, the user can browse a document on a terminal such as a cell phone. The user can read the entire content of the document, if other relevant reference information needs to be obtained, the user may need to search the relevant information in a browser. If the document is a complex article, the user may need to read the whole document first and then understand and summarize by themselves. The existing solutions aim to solve the problems during reading to improve efficiency (e.g., on-screen translation through OCR).

For example, the user can paste the text into a GPT platform (e.g., Bing browser) to generate a summary or generate related information through a dialogue. However, this approach requires a plurality of steps, and the device of the user may not have the corresponding GPT tool application.

For another example, by extracting the keyword, the related information (i.e., contents outside the current document) can be obtained in the browser as supplementary knowledge. However, this approach also requires a plurality of steps, the user needs to filter a large amount of information obtained through the browser, which increases information interference.

For the above problems, in the present disclosure, the text content can be zoomed in in the display interface of the application (e.g., photo albums, document management, notes, readers, etc.). The entire text (i.e., the text content above) can be recognized and understood. The core content (i.e., the summary content) can be summarized. The newly generated core content can be related to the distance (i.e., the length of the operation trajectory above) of the zoom-in operation. When the text content is zoomed in a certain degree, the entire document can be condensed to the smallest set (i.e., one sentence). On the contrary, the entire text can be reduced by performing the zoom-out operation on the text content. Meanwhile, the content related to the entire document can be obtained through the GPT technology. In some embodiments, the quantity of the obtained summary content sentences/summary level can be associated with the text paragraphs within the radius of the trigger area based on the zoom-out gesture.

As shown in FIG. 11, the content extracted by and associated with the zoom-in gesture and the zoom-out gesture changes dynamically in real-time. The focus point of the triggered gesture is used as the center. A quantity threshold of the summary sentences that need to be extracted can be determined through intelligent recognition (e.g., a paragraph, and a screen radius).

With the technical solution of the present disclosure, the operation can be intuitive and efficient. The technical solution of the present disclosure can facilitate the user to read the document and obtain the core information.

In this specification, embodiments are described progressively. Each embodiment focuses on the differences from other embodiments. For the same and similar parts among the embodiments, reference can be made to each other. For the apparatus of embodiments of the present disclosure, since the apparatus corresponds to the method of embodiments of the present disclosure, the description can be simple. For the relevant part, reference can be made to the description of method embodiments.

Those skilled in the art can further understand that the units and algorithm steps of the examples described according to embodiments of the present disclosure can be implemented by electronic hardware, computer software, or a combination thereof. To clearly illustrate the interchangeability of the hardware and the software, the composition and steps of the examples have been described generally according to the functions in the above description. Whether the functions are performed by hardware or software can depend on the specific application and design constraints of the technical solution. Those skilled in the art can apply different methods on each specific application to implement the described functions. However, the implementation cannot be considered beyond the scope of the present disclosure.

The steps of the methods or algorithms described in embodiments of the present disclosure can be implemented directly through the hardware, a software module performed by the processor, or a combination thereof. The software module can be stored in random access memory (RAM), memory, read-only memory (ROM), electrically programmable ROM, electrically erasable programmable ROM, registers, hard disks, removable disks, CD-ROMs, or any other form of storage mediums known in the art.

The above description of embodiments of the present disclosure can enable those skilled in the art to implement or use the present disclosure. Various modifications to embodiments of the present disclosure can be obvious to those skilled in the art. The general principle defined in the present specification can be implemented in other embodiments without departing from the spirit or scope of the present disclosure. Thus, the present disclosure is not limited to these embodiments of the present specification but should conform to the widest scope consistent with the principle and novel features of the present disclosure.

What is claimed is:

1. A processing method comprising:
obtaining an interactive operation for a text content;
in response to the text content being in a first operation mode, adjusting a summary content corresponding to the text content according to an operation parameter of the interactive operation, the summary content including at least one summary sentence; and
in response to the text content being in a second operation mode, adjusting a display scale of a display screen corresponding to the text content according to the operation parameter of the interactive operation;
wherein, under different operation parameters, a quantity of summary sentences included in the summary content is different.

2. The method according to claim 1, further comprising:
in response to the text content being in a third operation mode, simultaneously adjusting the summary content corresponding to the text content and the display scale of the display screen corresponding to the text content according to the operation parameter of the interactive operation.

3. The method according to claim 1, wherein:
the operation parameter correspondingly indicates adjusting the display scale to increase or decrease to a corresponding scale value;
in response to the display scale being in a first value range, a first quantity of summary sentences are included in the summary content;
in response to the display scale being in a second value range, a second quantity of summary sentences are included in the summary content; and
the first value range is greater than the second value range, and the first quantity is smaller than the second quantity.

4. The method according to claim 3, wherein adjusting the summary content corresponding to the text content according to the operation parameter of the interactive operation includes:
in response to the display screen being at a minimum scale value, if the operation parameter indicates adjusting the display scale to become smaller, obtaining a target content associated with the text content;
obtaining the summary content according to the target content and the text content.

5. The method according to claim 4, wherein the target content is a content obtained by searching in at least one data source according to a target keyword, and the target keyword is a keyword within the text content, and the target content includes at least one keyword matching the target keyword.

6. The method according to claim 4, further comprising, after obtaining the summary content according to the target keyword and the text content:
displaying the target content;
wherein the target content and the text content being displayed includes at least one of:
a display window where the target content is located being displayed above the display screen as a floating window;
the display window and the display screen being displayed side by side; or
the display window and the display screen being displayed in layers, and the display screen being output at the top.

7. The method according to claim 1, wherein:
the summary content is at least related to the content in a focus point area and the operation parameter, and the operation parameter at least includes an operation focus point of the interactive operation; and
the focus point area is the content area where the operation focus point is located in the display screen of the present content.

8. The method according to claim 1, wherein:
a generative pre-trained transformer model is configured to perform processing on at least the text content to obtain the summary content corresponding to the text content.

9. A processing apparatus comprising:
an operation acquisition unit configured to obtain an interactive operation for a text content, trigger a first processing unit in response to the text content being in a first operation mode, and trigger a second processing unit in response to the text content being in a second operation mode;
the first processing unit configured to adjust a summary content corresponding to the text content according to an operation parameter of the interactive operation, the summary content including at least one summary sentence; and
the second processing unit configured to adjust a display scale of a display screen corresponding to the text content according to the operation parameter of the interactive operation;
wherein, under different operation parameters, a quantity of summary sentences included in the summary content is different.

10. An electronic device comprising:
an input/output apparatus configured to output a text content and obtain an interactive operation for the text content;
one or more processors configured to:
in response to the text content being in a first operation mode, adjust a summary content corresponding to the text content according to an operation parameter of the interactive operation, the summary content including at least one summary sentence; and
in response to the text content being in a second operation mode, adjust a display scale of a display screen corresponding to the text content according to the operation parameter of the interactive operation;
wherein, under different operation parameters, a quantity of summary sentences included in the summary content is different.

11. The device according to claim 10, wherein the one or more processors are further configured to:
in response to the text content being in a third operation mode, simultaneously adjust the summary content corresponding to the text content and the display scale of the display screen corresponding to the text content according to the operation parameter of the interactive operation.

12. The device according to claim 10, wherein:
the operation parameter correspondingly indicates of adjusting the display scale to increase or decrease to a corresponding scale value;
in response to the display scale being in a first value range, a first quantity of summary sentences are included in the summary content;
in response to the display scale being in a second value range, a second quantity of summary sentences are included in the summary content; and
the first value range is greater than the second value range, and the first quantity is smaller than the second quantity.

13. The device according to claim 12, wherein the one or more processors are further configured to:
in response to the display screen being at a minimum scale value, if the operation parameter indicates of adjusting the display scale to become smaller, obtain a target content associated with the text content; and
obtain the summary content according to the target content and the text content.

14. The device according to claim 13, wherein the target content is a content obtained by searching in at least one data source according to a target keyword, and the target keyword is a keyword within the text content, and the target content includes at least one keyword matching the target keyword.

15. The device according to claim 14, wherein the one or more processors are further configured to, after obtaining the summary content according to the target keyword and the text content:
display the target content;
wherein the target content and the text content being displayed includes at least one of:
a display window where the target content is located being displayed above the display screen as a floating window;
the display window and the display screen being displayed side by side; or
the display window and the display screen being displayed in layers, and the display screen being output at the top.

16. The device according to claim 10, wherein:
the summary content is at least related to the content in a focus point area and the operation parameter, and the operation parameter at least includes an operation focus point of the interactive operation; and
the focus point area is the content area where the operation focus point is located in the display screen of the present content.

17. The device according to claim 10, wherein:
a generative pre-trained transformer model is configured to perform processing on at least the text content to obtain the summary content corresponding to the text content.
